(19) United States
(12) Patent Application Publication
(10) Pub. No.: US 2008/0046872 A1
(43) Pub. Date: Feb. 21, 2008

(54) COMPILER USING INTERACTIVE DESIGN MARKUP LANGUAGE

(76) Inventor: Greg J. Cooper, Toronto (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/741,165

(22) Filed: Apr. 27, 2007

Related U.S. Application Data
(60) Provisional application No. 60/797,309, filed on May 3, 2006.

(51) Int. Cl. G06F 9/45

(52) U.S. Cl. 717/140

(57) ABSTRACT

The present disclosure concerns a compiler process that generates application files for use with multiple user interface technologies from the same source input files. A compiler process of the exemplary embodiment has a pre-defined, fixed set of primitives that each user interface technology must support. This set includes such things as images, text and edit boxes. Each primitive has a set of named properties. These are as a group, referred to as widgets. The process relies on a generic data model that describes the data fields and executable code (referred to as GDMC) used in a user interface in a language independent manner. This data model serves as the basis for the parsing of code from text, programmatically generating code, applying transformations on code and the output of code to various executable formats. This is used to combine functionality defined by widgets with the functionality defined by the application code.

### CROSS REFERENCE TO RELATED APPLICATION

The present application claims priority from U.S. provisional application Ser. No. 60/797309 filed, May 3, 2006, which is incorporated herein by reference.

### FIELD OF THE INVENTION

The present invention concerns the development of the user interface of software applications that may be implemented on multiple user interface technologies.

### BACKGROUND ART

There are many different technologies used to implement application user interfaces. Examples include Internet browsers such, as Microsoft Internet Explorer™ and Mozilla FireFox™ and the Java Swing technology. Note: User interface technology is a distinct concept from that of operating system. An operating system is the technology that controls the fundamental behaviour of the computer, including how it stores information, how it displays information and how it interacts with peripheral devices. The set of operating systems includes Microsoft Windows™ and Sun Solaris™, User interface technology is the software that applications use to interact with the operating system in order to display information and respond to user input. Both the browser technology and the Java Swing technology support multiple operating systems.

Java™ is a programming language and run-time technology that supports multiple operating systems and is used by many software developers. In many cases, this programming language is used to provide, examples of how the invention operates. It is also used in the exemplary system. Conventional developer tools use an “object-oriented” approach to user interlace design. This approach allows the application developer to create forms (i.e. screens, windows, pages) and place visual components on those forms such as images and boxes in which text data is displayed and/or edited. Each visual component normally has a set of properties that control its behavior and appearance. For example, the box for editing text will have properties to control the font of the text and the color of the box. Visual components are also referred to as widgets and we will use that term from hereafter.

Conventional developer tools support a “data binding” mechanism which allows some of the properties of a visual component to be bound to the fields of a data object. When this is done, the value of that property is automatically kept in synchronization with the field of the data object by the user interface technology without requiring any application coding. This conventional data binding technology allows the code implementing the data objects to be defined independently of the code implementing the visual components. This is implemented through a concept of an observer and an observable. The data object is observable. The visual component is an observer. The widget observer “tells” the data object observable that it wants to be notified of any changes. The data object maintains a list of observers so that it can notify them when the time comes. When implemented in this manner, the widget must explicitly identify itself as an observer of the data object.

Another important point to note with conventional data binding is that it is only implemented on specific properties. Other visual component properties must be explicitly modified by writing code that changes based on the user actions or some other run-time occurrence.

Conventional developer tools are designed to build user interfaces for one of the user interface technologies which results in the application developer being committed to that technology until he/she invests a significant amount of time and money reengineering the user interface using another technology.

### SUMMARY OF THE INVENTION

The present disclosure concerns a generic data model that describes the data fields and executable code (hereafter referred to as GDMC) used in a user interface in a language independent manner. This data model serves as the basis for the parsing of code from text, programmatically generating code, applying transformations on code and the output of code to various executable formats.

A compiler process of the exemplary embodiment has a pre-defined, fixed set of primitives that each user interface technology must support. This set includes such things as images, text and edit boxes. Each primitive has a set of named properties. These are as a group, referred to as widgets.

Widgets are defined using a widget class. Widget classes define their own set of named properties and provide a process that distills each widget defined using that class into one or more primitives, zero or more data fields and zero or more actions (that contain code that performs operations on the data fields). All fields and all code are defined using the GDMC described above. During a distillation process, the value assigned to each property of the widget is normally assigned to one or more properties of the primitives generated by the widget class, sometimes with transformations applied to them. Other primitive properties have default expressions assigned to them.

This distillation of widgets into primitives, fields and actions is one important feature of the invention. In conventional systems, widgets render themselves directly into HTML or Java code or some other construct that is specific to a particular user interface technology. With the exemplary embodiment, the widgets render themselves into objects that all of the user interface technology compilers understand and can therefore render into a format usable on their technology.

A prior art data binding mechanism is not sufficient when this technique is used. One reason for this is that the application developer designs his or her forms using widgets and the widgets themselves do not exist in the run-time environment because they have been distilled into primitives. So, if an application developer writes code to assign a value to a widget property, there would need to be a relatively complex process to translate that code into an assignment of that value, possibly with transformations applied, to one or more primitive properties.

For example, consider a LabelledEditBox widget class that includes a static Text caption and an EditBox for displaying and editing a data field. The LabelledEditBox has a “left” property which defines its horizontal coordinate. It also has a “labelWidth” property which defines how wide the Text label is. When an instance of a LabelledEditBox called “editName” is compiled, it creates the EditBox primitive and it assigns its “left” property with the expression “editName.left+editName,labelWidth”. This causes the EditBox to be placed just to the right of the Text label. If an application programmer had code that assigned the value 200 to the editName.left property and 60 to the editName.labelWidth property, the User Interface Technology compiler would have to ensure that the EditBox's left property also got updated correctly, to the value of 200+60.

Another reason why conventional data binding was not sufficient was its dependence on explicit references to a single data object that it is observing. If a primitive property is defined using a complex expression such as selection.quantity*product.price, then the primitive should be observing not just one data object. Instead, it should be observing the quantity field of selection, and the price field of product.

Therefore, a more sophisticated data binding implementation is needed than the data binding used in conventional systems. As described above, conventional systems rely on explicit binding to a single data field for selected properties. In IDML, every primitive property (created by the widgets) is defined using art expression. At run-time, when the primitive determines fee values for each of its properties, the primitive is required to use a newly defined process added through practice of the exemplary embodiment to “capture all of the observables” that are accessed in evaluating the expression for each property.
For example, the enabled property of a button component might be set to productSelection.isComplete( ). This means that the button is enabled only when the isComplete method of the productSelection field returns true. The isComplete method in turn checks the style field and the quantity field, both of which are observables. Therefore, the enabled property captures each of those observables and thus is notified when any one of them is changed so that it may reevaluate itself.
User application technologies may implement optimizations using the GDMC by inspecting the expression for each property. For example, while each component property is defined using an expression, one type of expression is a numeric constant. A user interface technology, when it builds the content for a primitive property, may not capture observables when it is defined as a numeric constant, improving the application performance.
In addition to straightforward change notifications, collection observables may provide more detailed notifications identifying elements that have been inserted, changed or deleted.

An application developer may use widget classes created by him/herself or those created by another developer. An application developer builds his or her forms by creating their own fields and actions and adding widgets based on widget classes. The application developer may assign expressions to any of the named properties defined in the widget classes for each widget. The application developer may add fields and actions directly to his form and/or he/she may create a separate canvas model, using a standard programming language like Java. This canvas model would contain its own fields and actions. Herein, canvas model refers to a collection of fields and actions in a separate source file, not a part of the form definition file.

The building of the forms may be done by manually creating an XML file containing the definitions of the fields, actions and widgets. It may also be done using the interactive, visual editor. Within the editor, the widget classes used by the application developer distill themselves into primitives using the method described above and these primitives are immediately rendered to the computer screen. Furthermore, the on screen visuals are rendered using the observer technique mentioned above so that they automatically update themselves when the original widget properties are modified. The compiler is responsible for the rendering of the application developer forms into the content required for each user interface technology through which the application is being deployed.

A first phase of this process is to create a collection of primitives, fields and actions from the application's source definition. The exemplary embodiment does this by building a collection of all of the primitives, fields and actions that are distilled from widgets in the form and the fields and actions defined by the application developer.

A compiler phase is repeated for each target user interface technology. Each user interface technology must then render these primitives, fields and actions into the content that it requires to implement them at run-time.

It is important to note that this compiler process is also used in the context of a plug-in component to third party development tools. Specifically, the process is used as an extension to the Java Server Faces technology standard developed by a consortium of industry experts. This allows it to be used in third party development tools that support this standard.

### BRIEF DESCRIPTION OF THE DRAWINGS

FIG. 1 is a schematic representation of a computer;

FIG. 2 is a schematic representation of a generic data model 100 for code (GDMC) and shows different types of input, the optional use of transformations, merges from multiple inputs and different types of output. The system for practicing the invention is called the Interactive Design Markup Language (IDML);

FIG. 3 is a schematic representation of an IDML compiler process 110 up to the point where it “hands off” an output to the specific user interface technology compilers for rendering the file(s) necessary to display a page;

FIG. 4 is a schematic representation of an example process 130 of how a widget is defined and how the widget class distills itself into primitives that the user interface technology compiler understands;

FIG. 5A-5D is a complete flowchart of the first phase of the IDML compiler process for the sample form file;

FIG. 5E shows what the form would like in one user interface technology, specifically Microsoft's Internet Explorer™;

FIG. 6 shows the continuation of the process in FIG. 4 for the compiler for the Internet browser user interface technology;

FIGS. 7A-7C are a detailed flowchart of how the browser compiler operates;

FIG. 8 illustrates how server actions are implemented in a browser client, including when new forms are loaded into the frame as a result of the action;

FIG. 9 is a schematic representation of an example process of an observer capturing observables. Specifically it shows a button primitive's observer capturing observables in the setting of its enabled property; and

FIG. 10 is a schematic representation of an example process of an observable notifying its observers. Specifically it shows an edit box primitive assigning data to the field to which it is bound to and how it would cause the process in FIG. 2 to be re-enacted.

### EXEMPLARY SYSTEM FOR PRACTICING THE INVENTION

### Browser Technology Compiler

Currently, the browser is the roost common user interface technology. It is also the most complex in terms of implementation due to the limitations of its design. Therefore, the invention includes the techniques required to implement a compiler for browser deployments using a web server such as but not limited to a J2EE (Java) server. The browser technology compiler creates Hypertext Markup Language (HTML), and Javascript code for execution on the browser client and the executable files that execute on a web server.

In order to make code defined using the GDMC available in a browser environment regardless of any but the most stringent and rarely used browser security settings, the browser technology compiler includes the ability to translate that code into Javascript, a presently well understood programming language whose syntax is understood by all presently available browser technologies. This functionality makes it possible to generate Javascript from source files such as Java, embedded source code in form definition files and programmatically generated code. This, in turn, makes it possible to implement the observable and observer function described above on the browser client.

In addition to this Javascript generation and a number of functions, the browser technology compiler requires two other important features;
There is the need to implement server-side actions that may or may not cause a new form to be loaded into the same window (or frame) in an optimal manner.
As mentioned above, the observer process includes the ability for collections of elements to provide specialized update notifications when single elements are inserted, changed or deleted. These update processes need to be processed within acceptable performance constraints.

The exemplary system implements a data model for an Interactive Design Markup Language or IDML.

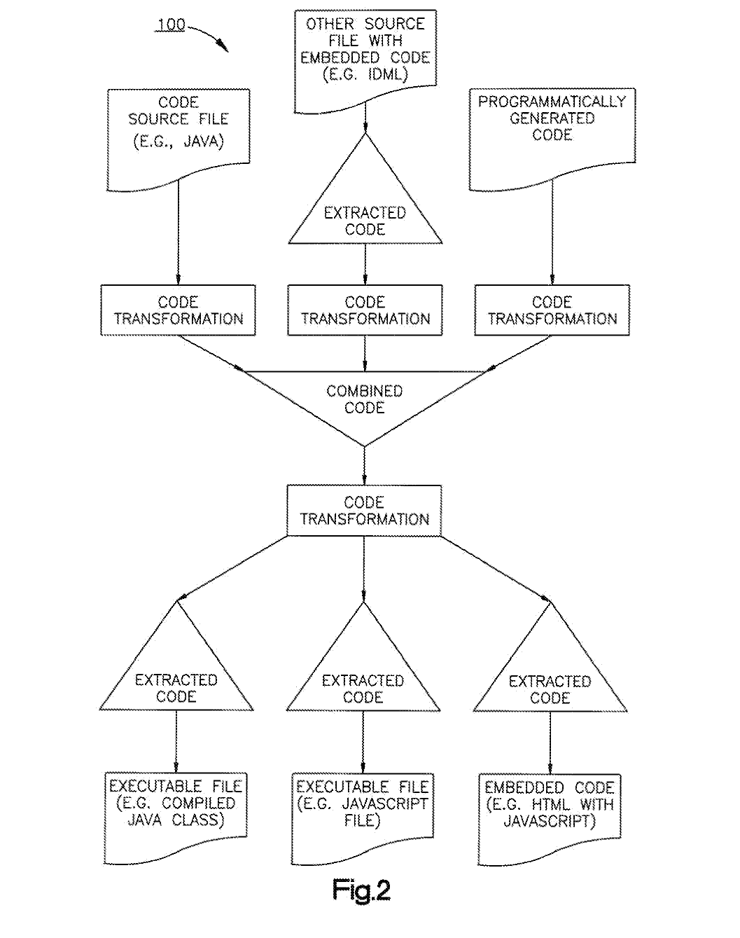

FIG. 2 illustrates a generic data model for code (GDMC) from the perspective of different types of input, the use of transformations, merges from multiple inputs and different types of output. An input data model or partial data model may be constructed in a number of ways. The most common method is to parse source code that is defined in text files such as the source code that may be found in a lava source file. For ease and clarity of exposition, the exemplary system and method will be described using Java as the source programming language, the browser user interface technology and thus HTML and Javascript as the output languages unless otherwise noted. Those skilled in the art will recognize that the invention is not limited thereto. The preferred system and method can be used for other source programming languages and other user interface technologies.

The GDMC is capable of representing any structured procedural code such as is defined by C, C++, Java or Microsoft Visual Basic™. It includes the facility to represent classes that are used in object-oriented languages such as C++, Java and Microsoft Visual Basic™. Classes contain both fields containing data and subroutines that perform operations on that data.

The GDMC includes the facility to represent overloaded subroutines (or methods as they are called by most object-oriented languages). These are multiple subroutines with the same name but different sets of parameters. This is important in being able to represent Java code since the Java syntax supports this feature.

In some cases, such as is the case with IDML files that have fields and actions embedded in them, source code may be extracted from mixed input files as text and a data model may be built from that. A GDMC may also be built programmatically. For example, an animation widget class may create code to increment a frame counter so that it may be included in an action which in turn is called by a timer 30 times a second. Once code is represented by the data model, transformations may be applied to that data model. Also, code may be merged together from any number of sources. In the end, code may be output to a number of different targets, including compiled executables such as compiled Java class files, executable script files such as Javascript, and it may also be embedded in other files such as when Javascript is embedded in HTML files.

### Interactive Design Markup Language (IDML) Compilation Process

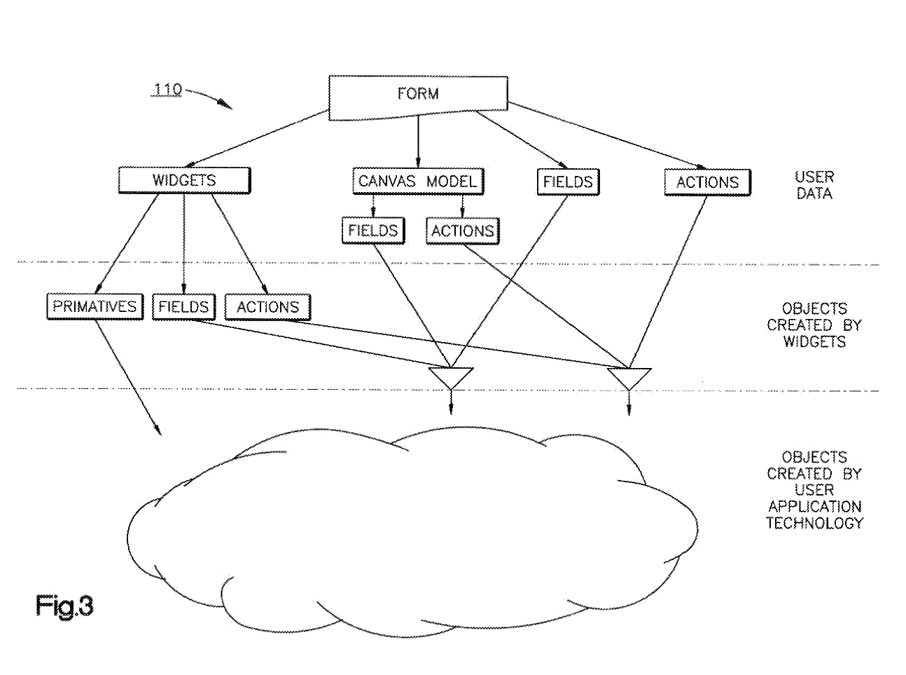

FIG. 3 illustrates an IDML compilation process 110 up to the point where the primitives, fields and actions are passed to a user interface technology compiler.

One input to the compilation process 110 is an IDML source file defining a form which contains widgets, fields and actions and optionally specifies a separate Java source file that defines additional fields and actions. Together, this data constitutes all of the user data that serves as input to the process. An IDML source file may identify a lava class file which defines the canvas model which also contains fields and actions.

The preferred implementation of this source content is an XML file with Java source optionally embedded within for the fields and actions.

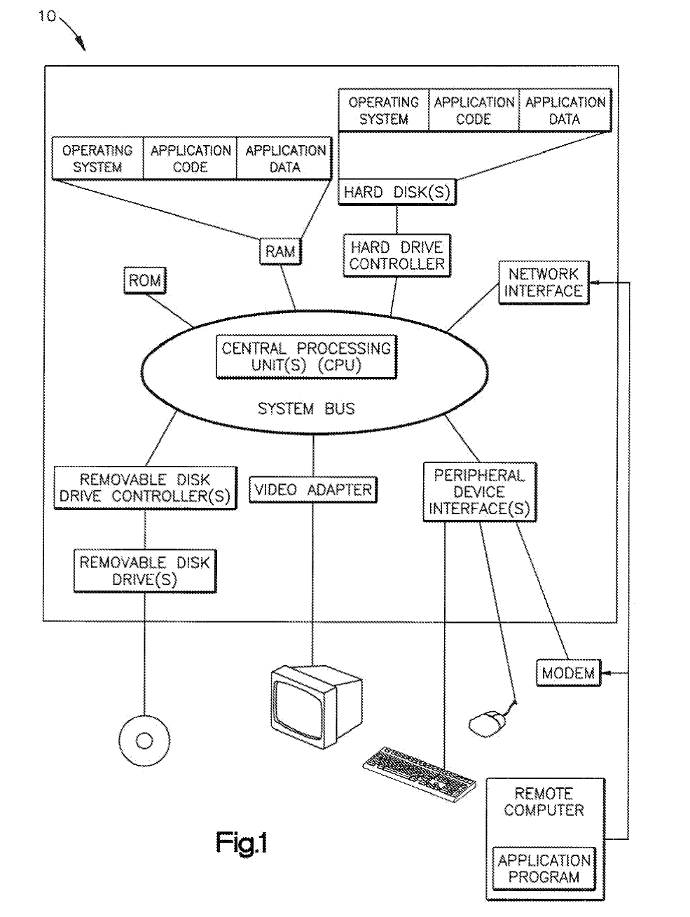

The IDML compiler uses a standard XML parser to extract the widget definitions but also uses the code parsing technique described in FIG. 1 to translate the widget properties, which are defined using Java expressions, into the data model for code.

It also uses the process in FIG. 2 regarding the GDMC to parse aspects of the definitions of the fields and actions where specified in the IDML source file and/or the Java source file defining the canvas model.

Each widget in the form is defined using a widget class. An example of a widget class is LabelledEditBox that is an edit box with a text label beside it. Another example is an Animation widget class.

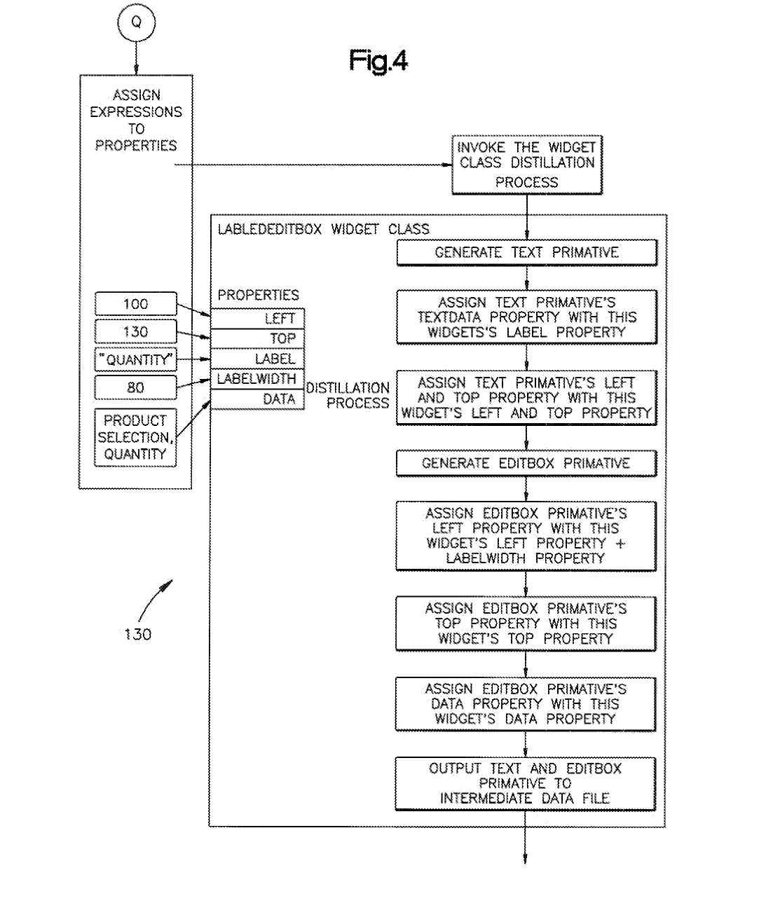

Each widget class is responsible for distilling its widgets into one or more primitives, zero or more fields and zero or more actions. For example, the LabelledEditBox class distills its widgets into a Text primitive and an EditBox primitive. This is depicted in the example process 130 of FIG. 3. FIG. 4A is a full flowchart of the first phase of the compiler process for the sample form file. The Animation class distills its widgets into a Container primitive, a playFlag field, a currentFrame field, an incrementFrame action, a Timer primitive that invokes the incrementFrame action and actions called play and stop to activate and deactivate the timer.

This distillation of widgets into primitives, fields and actions is one important feature of the invention. In prior art systems, widgets render themselves directly into HTML or Java code or some other construct that is specific to a particular user interface technology. With this invention, the widgets render themselves into object primitives that all of the user interface technology compilers understand and can therefore render into a format usable on their technology.

The primitives that are generated have their own properties which are defined using a combination of the property settings of the source widget, possibly with transformations applied, and default values defined by the widget class.

All of the primitives generated by all of the widgets are combined into one collection. All of the fields generated by all of the widgets, all of the fields from the IDML source file and all of the fields from the canvas model are combined into one collection. And, this same process is repeated for actions.

Thus, the output from this first phase of the IDML compilation process is a collection of primitives, a collection of fields and a collection of actions. These collections are passed on to the compiler for each user interface technology which must be able to interpret all such primitives.

For ease and clarity of exposition only, the exemplary system and method will be described as passing this content to the User Interface Technology compiler using an XML file. Those skilled in the art will recognize that the invention is not limited thereto. This includes the possibility of the passing of data using objects inside the memory of the computer.

### Sample Form File and Compiler First Phase Output

Table 1 lists the contents 150 of an XML form definition file and Table 2 lists the intermediate content 160 passed to a user interface technology compiler.

TABLE 1
Representative Form Definition File

```
<Canvas id=”SampleForm”>
    <Field id=”productSelection”
    type=”com.sbokwop.test.ProductSelection”/>
    <Field id=”message” type=”String”/>
    <Action id=”purchase”>
        <Code>
            if( Product.purchase( productSelection ) )
            {
                navigator.swap( “EnterPaymentDetails”,
                productSelection );
            }
            else
            {
                message = “Product not purchased”;
            }
        </Code>
    </Action>
    <Widget id=”editStyle” class=”LabelledEditBox”>
        <Property id=”left”>100</Property>
        <Property id=”top”>100</Property>
        <Property id=”label”>”Style”</Property>
        <Property id=”labelWidth”>80</Property>
        <Property id=”data”>productSelection.style</Property>
    </Widget>
        <Widget id=”editQuantity” class=”LabelledEditBox”>
        <Property id=”left”>100</Property>
        <Property id=”top”>130</Property>
        <Property id=”label”>”Quantity”</Property>
        <Property id=”labelWidth”>80</Property>
        <Property id=”data”>productSelection.quantity</Property>
    </Widget>
    <Widget id=”buttonPurchase” class=”Button”>
        <Property id=”left”>100</Property>
        <Property id=”top”>200</Property>
        <Property id=”label”>”Purchase”</Property>
        <Property id=”action”>Purchase( )</Property>
        <Property id=”enabled”>productSelection.isComplete( )</
        Property>
    </Widget>
    <Widget id=”textMessage” class=”Text”>
        <Property id=”left”>100</Property>
        <Property id=”top”>300</Property>
        <Property id=”width”>200</Property>
        <Property id=”data”>message</Property>
    </Widget>
</Canvas>
```

TABLE 2
Representative Intermediate Compiler File

```
<CompilerFile id=”SampleForm”>
    <Field id=”productSelection”
    type=”com.sbokwop.test.ProductSelection”/>
    <Field id=”message” type=”String”/>
    <Action id=”purchase”>
        <Code>
            if( Product.purchase( productSelection ) )
            {
                navigator.swap( “EnterPaymentDetails”,
                productSelection );
            }
            else
            {
                message = “Product not purchased”;
            }
        </Code>
    </Action>
    <Primitive id=”editStyleLabel” class=”Text”>
        <Property id=”left”>100</Property>
        <Property id=”top”>100</Property>
        <Property id=”width”>80</Property>
        <Property id=”height”>20</Property>
        <Property id=”text”>”Style”</Property>
    </Primitive>
    <Primitive id=”editStyleBox” class=”EditBox”>
        <Property id=”left”>100+80</Property>
        <Property id=”top”>100</Property>
        <Property id=”width”>100</Property>
        <Property id=”height”>20</Property>
        <Property id=”data”>productSelection.style</Property>
    </Primitive>
    <Primitive id=”editQuantityLabel” class=”Text”>
        <Property id=”left”>100</Property>
        <Property id=”top”>130</Property>
        <Property id=”width”>80</Property>
        <Property id=”height”>20</Property>
        <Property id=”text”>”Quantity”</Property>
    </Primitive>
    <Primitive id=”editQuantityBox” class=”EditBox”>
        <Property id=”left”>100+80</Property>
        <Property id=”top”>130</Property>
        <Property id=”width”>100</Property>
        <Property id=”height”>20</Property>
        <Property id=”data”>productSelection.quantity</Property>
    </Primitive>
    <Primitive id=”buttonPurchase” class=”Button”>
        <Property id=”left”>100</Property>
        <Property id=”top”>200</Property>
        <Property id=”width”>100</Property>
        <Property id=”height”>20</Property>
        <Property id=”label”>”Purchase”</Property>
        <Property id=”action”>Purchase( )</Property>
        <Property id=”enabled”>productSelection.isComplete( )</
        Property>
    </Primitive>
    <Widget id=”textMessage” class=”Text”>
        <Property id=”left”>100</Property>
        <Property id=”top”>300</Property>
        <Property id=”width”>200</Property>
        <Property id=”height”>20</Property>
        <Property id=”data”>message</Property>
    </Widget>
</CompilerFile>
```

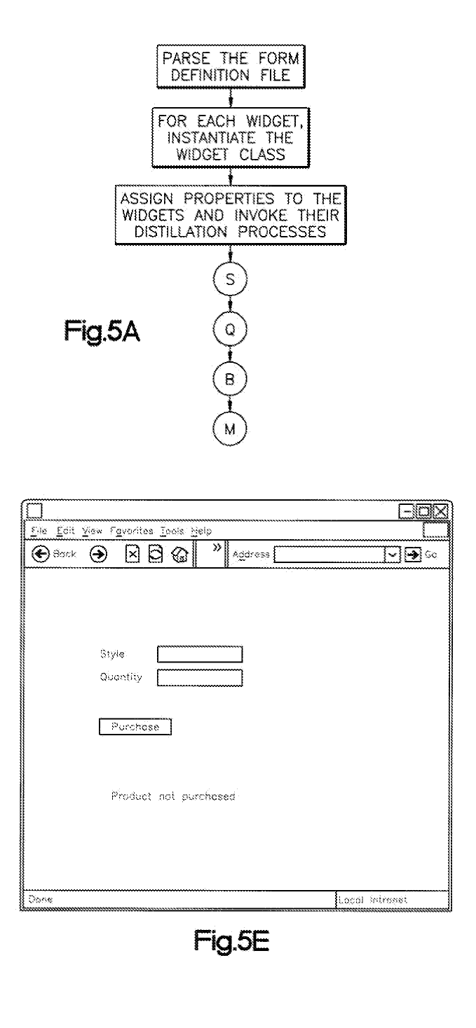

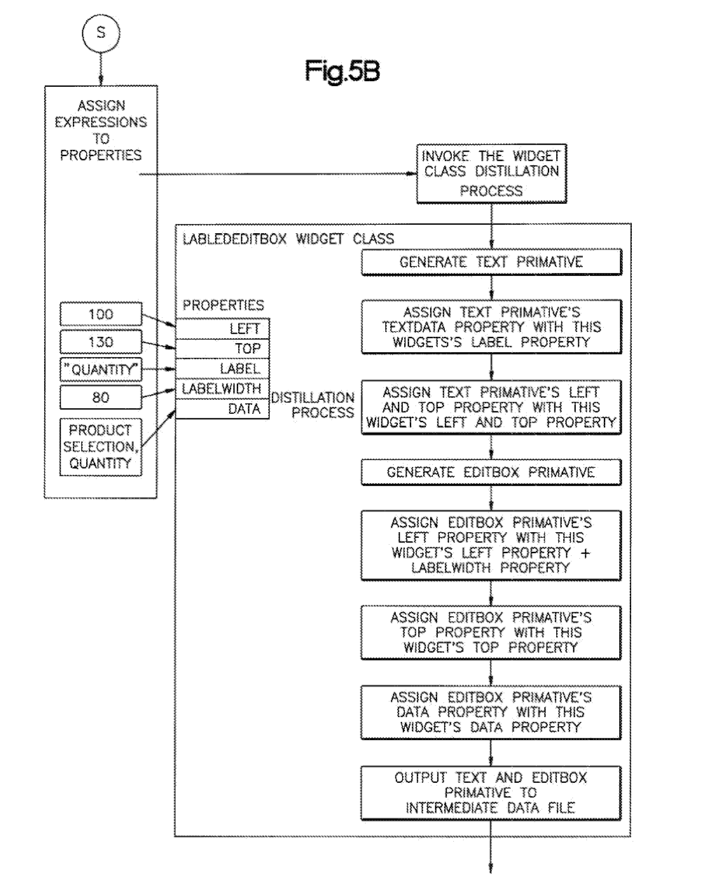

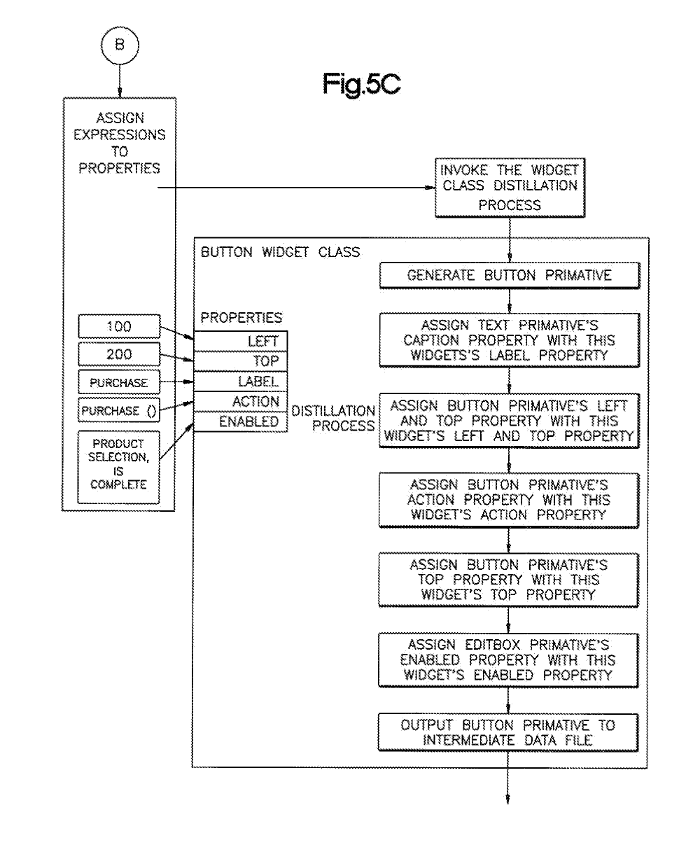

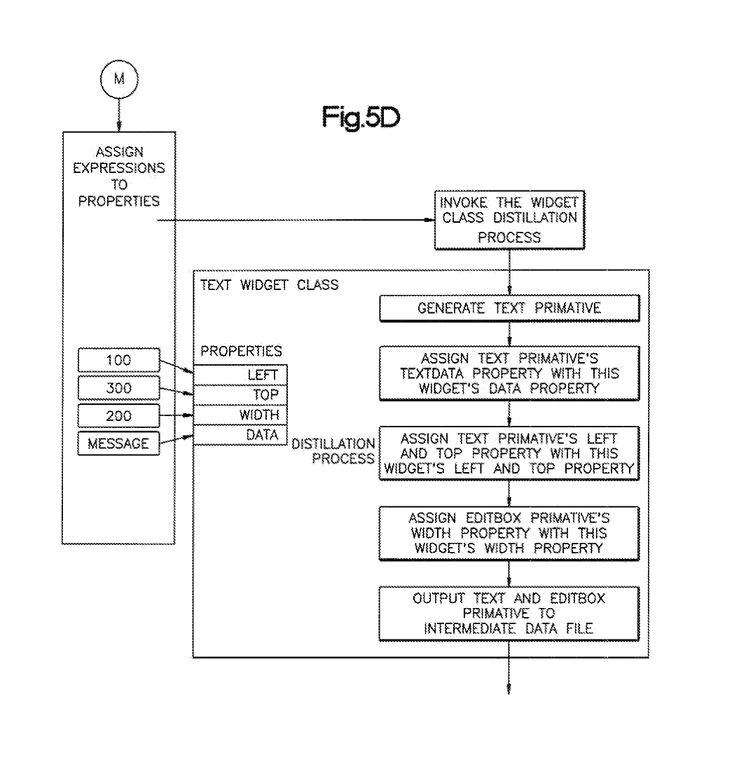

The form (whose appearance in a representative user technology is provided in FIG. 5E) is simple and consists of a ProductSelection field defining a style and quantity, a String field defining a message to the user and an action to purchase the product. If the purchase is successful, another form is loaded into the frame. Otherwise, it assigns a value to the message field. It then includes two LabelledEditBoxes to enter the style and quantity and the Button to invoke the action.

Turning to Table 2, one sees in the output file that the fields and defined actions are passed through as is. The LabelledEditBoxes have been distilled themselves into two primitives as discussed in the examples above. Some default properties (e.g. width) have also been filled in.

### Animation Form File and Compiler First Phase Output

Table 3 lists the contents of what an XML form definition file might look like that includes the Animation widget class mentioned above. Table 4 lists the contents of what the intermediate content passed to a user interface technology compiler might look like for this form file.

TABLE 3
Representative Form Definition File - Animation

```
<Canvas id=”AnimationForm”>
    <Widget id=”anim” class=”Animation”>
        <Property id=”left”>100</Property>
        <Property id=”top”>100</Property>
        <Property id=”frameCount”>60</Property>
        <Widget id=”img” class=”Image”>
            <Property id=”left”>100+10*anim.currentFrame</
            Property>
            <Property id=”top”>20</Property>
            <Property id=”file”>”train.gif”</Property>
        </Widget>
    </Widget>
    <Widget id=”buttonPlay” class=”Button”>
        <Property id=”left”>100</Property>
        <Property id=”top”>500</Property>
        <Property id=”label”>”Play”</Property>
        <Property id=”action”>anim.play( )</Property>
    </Widget>
</Canvas>
```

TABLE 4
Representative Intermediate Compiler File - Animation

```
<CompilerFile id=”AnimationForm”>
    <Field id=”anim_currentFrame” type=”int”/>
    <Field id=”anim_playFlag” type=”boolean”/>
    <Action id=”anim_play”>
        <Code>
            anim_playFlag = true;
        <Code>
    <Action>
    <Action id=”anim_frameIncrement”>
        <Code>
            anim_currentFrame += 1;
            if( anim_currentFrame == 60 )
            {
                anim_playFlag = false;
            }
        </Code>
    </Action>
    <Primitive id=”animContainer” class=”Container”>
        <Property id=”left”>100</Property>
        <Property id=”top”>100</Property>
        <Property id=”width”>400</Property>
        <Property id=”height”>400</Property>
        <Primitive id=”img” class=”Image”>
            <Property id=”left”>100+anim_currentFrame*10</
            Property>
            <Property id=”top”>20</Property>
            <Property id=”file”>”train.gif”</Property>
        </Primitive>
    </Primitive>
    <Primitive id=”buttonPlay” class=”Button”>
        <Property id=”left”>100</Property>
        <Property id=”top”>600</Property>
        <Property id=”width”>100</Property>
        <Property id=”height”>20</Property>
        <Property id=”label”>”Play”</Property>
        <Property id=”action”>anim_play( )</Property>
    </Primitive>
    <Primitive id=”animTimer” class=”Timer”>
        <Property id=”enabled”>anim_playFlag</Property>
        <Property id=”action”>anim_frameIncrement( )</Property>
        <Property id=”interval”>1/30</Property>
    </Primitive>
</CompilerFile>
```

Tables 3 and 4 illustrate a slightly more complex example of the distillation process using a widget class that distills itself not just into primitives but also into fields and actions. An Image widget is contained “within” the Animation widget. Also, the Animation widget includes a “currentFrame” property. This is a property widget whose expression is defaulted to point to the integer field it creates during the distillation process. Also, the Button widget refers to the “play( )” action which is defined by the widget class.

In this case, the name of the animation widget (“anim”) is added to the field and action names to identify them. Two fields are created to control the current state of the animation. Two actions are used to change the state of the animation. The second action, “anim_incrementFrame”, is called by a Timer primitive created by the Animation widget class.

### Computer System.

FIG. 1 depicts an exemplary computer 10 with a remote computer attached. The system includes a conventional computer, including one or more central processing units, a system bus that connects it to the other components, RAM or random-access memory and ROM or read-only memory. The system bus may take a number of forms, of which any expert in the art will be familiar.

The computer also includes a hard, drive controller for reading from or writing to one or more hard disks; one or more removable disk controllers connected to drives for reading from and writing to removable media such as floppy diskettes, CD-ROMs, recordable CD-ROMs, zip drives, etc. Those familiar with the art will recognize that any removable media may be used in the exemplary environment. The controllers are also connected to the CPU(s) through a system bus. The drives and their associated media provide persistent storage of operating systems, application code and application data.

A number of data elements may be stored on the hard disk, removable media, ROM or RAM, including one or more operating systems, one or more application programs and program data. A user may enter invoke actions in the operating system or an application through input devices such as a keyboard and pointing device. Other input devices (not shown) may include a microphone, joystick, game pad, satellite dish, scanner, or the like. These peripheral devices all have their own connectors to the computer. A monitor or other type of display device is normally also connected to the video adapter which is in turn connected to the CPU(s) through the system bus. Other peripheral devices such as speakers or printers may also be attached through connectors.

The computer may be connected to one or more remote computers. The remote computer may be another computer like the one being described, possibly with one or network devices, such as router or hub, in between. The remote computers may also be much simpler, such as cell phones, or more complex computing devices. The connection is normally made through an internal network interface to an external connector to a network cable. It may also be made through a modem, another peripheral device, which may be internal or external to the chassis of the computer. It will be appreciated that the network connections shown are exemplary and other means of establishing a communications link between the computers may be used.

### Browser Compilation Process

The exemplary embodiment of the invention also builds the files necessary for deploying an application user interface on a browser such as Microsoft Internet Explorer™ and Mozilla FireFox™.

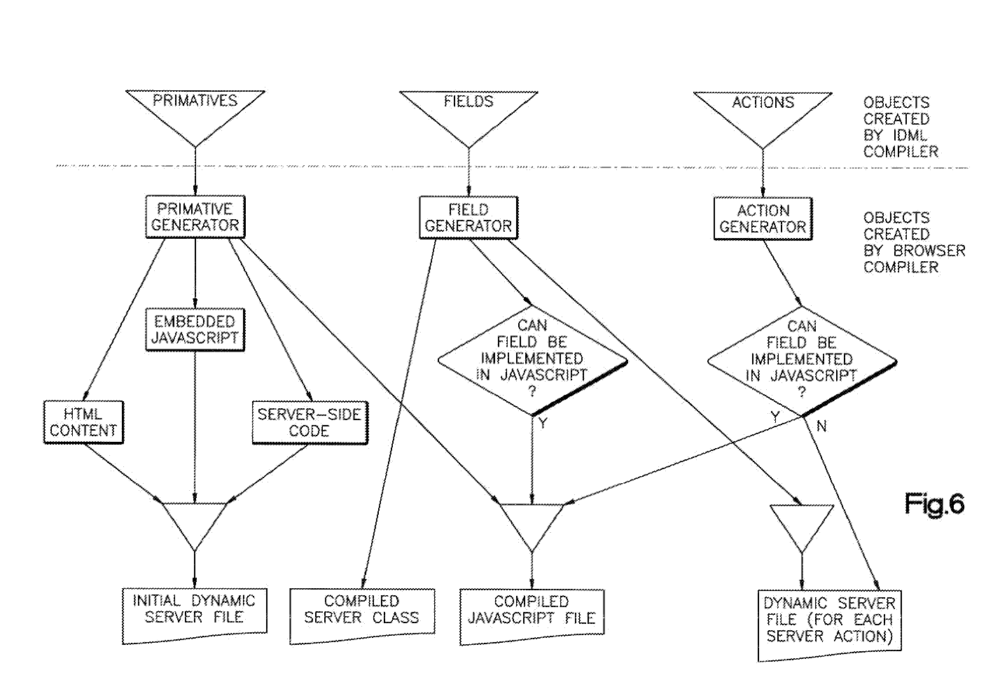

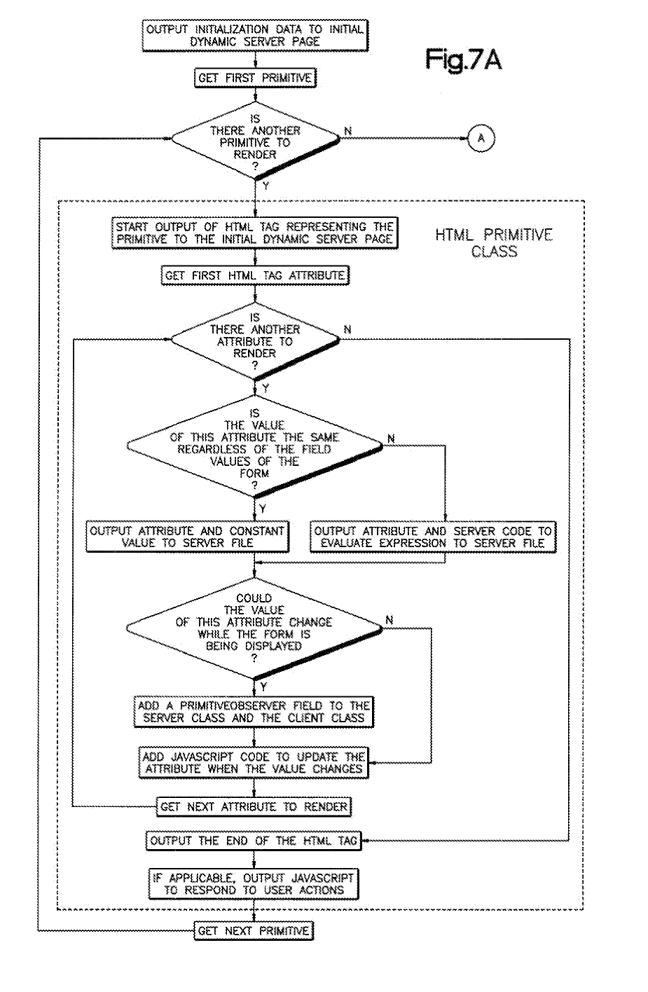

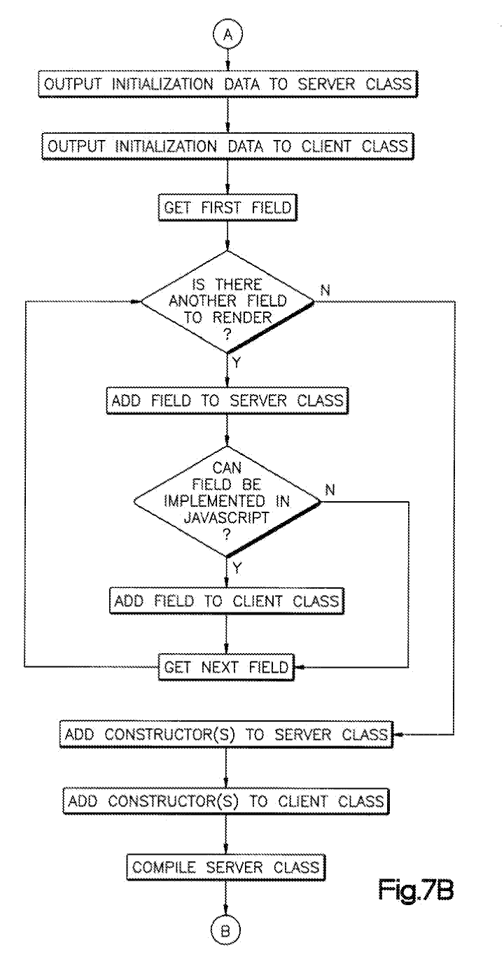

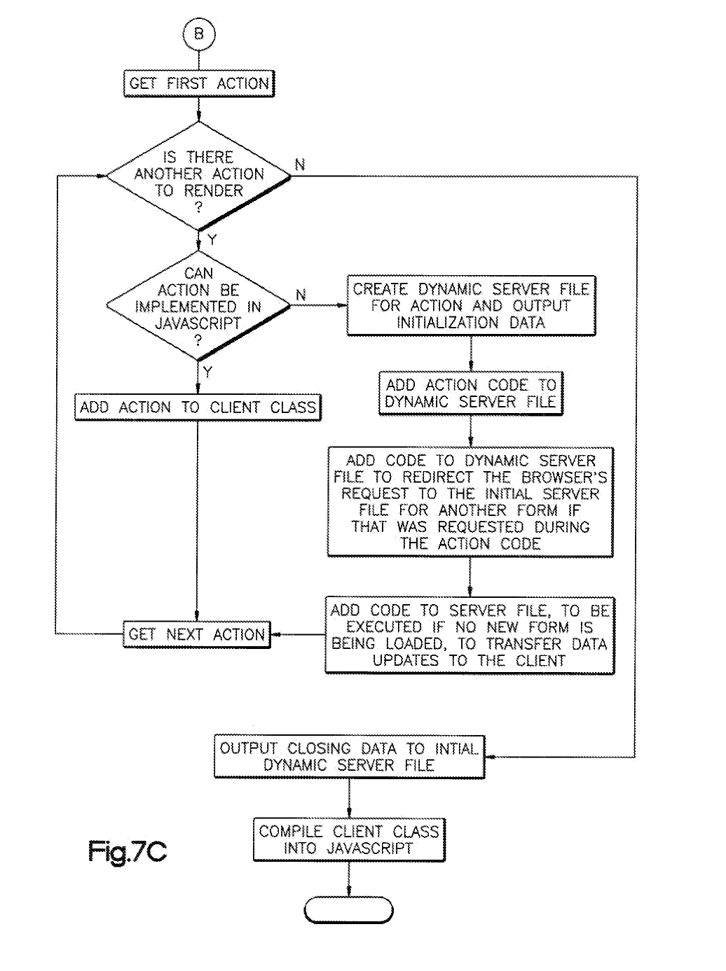

FIG. 6 illustrates a browser compiler process which operates on the inputs it receives from the first phase of the IDML compiler process shown in FIGS. 2 and 3. The browser compilation process relies heavily on an ability to generate Javascript code from the GDMC described above. Details on the generation of Javascript code from the GDMC are provided below. The primitive generator of the browser compiler produces a number of outputs. It creates HTML content to represent the primitive on the browser. For example, the compiler creates an <INPUT> tag for an EditBox primitive where the TYPE attribute is set to TEXT. In the case of HTML tag attributes whose initial value may vary depending on the run-time context, the primitive generator creates server-side code to fill in the correct value before it is downloaded to the browser client.

In the case of HTML tag attributes whose value may change while the form is being displayed, it embeds Javascript code in the HTML output to keep that value up-to-date. This Javascript code relies on the observable and observer process identified above. How this process works within the browser technology is described in detail below.

An HTML tag may also require Javascript to handle user actions such as when the user clicks on a Button primitive or when the user enters text into an EditBox primitive.

For each field that must be implemented in the form, a field and the methods to retrieve its value and assign it a new value are added to the server-side class. If the field can be implemented in Javascript, the field and these methods are added to the client-side class. Also, server-side code is added to the Initial dynamic server page to transfer the initial values of the field to the client.

For each action that may be implemented in Javascript, a corresponding function is added to the client-side class. For each action that may not be implemented in Javascript, a dynamic server file is created (a Java Server Page (JSP) in the case of J2EE servers). In these files, for fields that are accessed within the action, server-side code is added to transfer fields from the client to the server and back from the server to the client.

The HTML content, the embedded Javascript and the embedded server-side code are all merged into one dynamic server file.

The client-side class is compiled into Javascript. The server-side class is compiled into an executable Java class file.

### Javascript Generation

There are many similarities between Javascript syntax and Java syntax since Javascript is roughly modelled after Java. But, there are a number of differences. This is a list of some of the bigger differences:
Javascript uses a concept called prototypes to create multiple objects that share the same functions. Java uses classes.
The Java run-time environment loads Java class fries “on demand” when they are first encountered. It is not possible to do this in Javascript.
When a Java class is first accessed, the static fields are initialized and static initializers are executed. Static initializers are simply blocks of procedural code.
Java supports function overloading which allows a Java class to have multiple functions with the same name but different sets of parameters.
Java supports inner classes which have implied pointers to their parent class.

The GDMC has the means of parsing and representing all of these constructs. The browser technology compiler required a Javascript generator to translate this GDMC into Javascript code.

Table 5 shows a Java source code file for the ProductSelection class mentioned above. It has a style and a quantity field and a method called isComplete to indicate if the two fields have both been filled in. It also has a static initializer, an overloaded function and an inner class to illustrate the more complex elements of Java syntax to represent in Javascript.

TABLE 5
ProductSelection Java Source File

```
package com.sbokwop.test;
import.com.sbokwop.alert.ObservableProperty:
public class ProductSeletion
{
    String style;
    double quantity;
    ObscrvableProperty propStyle;
    ObservableProperty propQuautity;
    static String[ ] listStyle;
    slatic
    {
        listStyle = new String[3];
        listStyle[0] = ”Square”;
        listStyle[1] = ”Circular”;
        listStyle[2] = ”Triangular”;
    }
    public String getStyle( )
        {
        propStyle = ObservableProperty.notifyAccess( propStyle );
    return style;
    }
    public void setStyle( String param )
        {
        ObservableProperty.notifyUpdate( propStyle );
        style = param;
    }
    public double getQuantity( )
    {
        propStyle = ObservableProperty.notifyAccess( propStyle );
        return quantity;
    }
    public void setQuantity( double param )
    {
        ObservableProperty.notifyUpdate( propStyle );
        quantity = param;
    }
    public String[ ] getListStyles( )
    {
        return listStyle;
    }
    /**
    * Returns true only if a style is selected and the quantity
    * is greater than 0.0.
    */
    public boolean isComplete( )
    {
        return getStyle( ) != null && getQuantity( ) > 0,0;
    }
    /**
    * Purchase the product, allowing less than the desired quantity
    * to be purchased if less available.
    */
    public void purchase( )
    {
        Product.doPurchase( style, quantity, false );
    }
    /**
    * Same as above except that if the allOrNothing parameter
    * is true, then only complete the purchase if the entire
    * quantity is available.
    */
    public void purchase( boolean allOrNothing )
    {
        Product.doPurchase( style, quantity, allOrNothing );
    }
    /**
    * Example class to illustrate the implementation
    * of inner classes in Javascript.
    */
    class InnerClass
    {
        public void setStyleByIndex( int param )
        {
            setStyle( listStyle[param]);
        }
    }
}
```

Using well know techniques, the Java source is parsed into an internal data structure. Table 6 shows the Javascript output generated to represent this class oh the browser.

TABLE 6
ProductSelection Compiled Javascript

```
com_sbokwop_test_ProductSelection_Observer = new ClassLoaderObserver(
“com/sbokwop/test/ProductSelection.js” );
com_sbokwop_test_ProductSelection_Observer.addFilename( “java/lang/Object.js” )
com_sbokwop_test_ProductSelection_Observer.addFilename( “java/lang/Class.js” )
loadDependentClass( com_sbokwop_test_ProductSelection_Observer);
function com_sbokwop_test_ProductSelection_InstanceInit( )
{
    com_sbokwop_test_ProductSelection_StaticInit( );
    this.style = null;
    this.quantity = 0;
    this.propStyle = null;
    this.propQuantity = null;
}
function com_sbokwop_test_ProductSelection_staticgetlistStyle( )
{
    com_sbokwop_test_ProductSelection_StaticInit( );
    return com_sbokwop_test_ProductSelection_listStyle;
}
function com_sbokwop_test_ProductSelection_getStyle( )
{
    this.propStyle=com_sbokwop_alert_ObservableProperty_notifyAccess(this.propStyle);
    return this.style;
}
function com_sbokwop_test_ProductSelection_setStyle( param )
{
    com_sbokwop_alert_ObservableProperty_notifyUpdate(this.propStyle);
    this.style=param;
}
function_com_sbokwop_test_ProductSelection_getQuantity( )
{
    this.propStyle=com_sbokwop_alert_ObservableProperty_notifyAccess(this.propStyle);
    return this.quntity;
}
function com_sbokwop_test_ProductSelection_setQuantity( param )
{
    com_sbokwop_alert_ObservableProperty_notifyUpdate(this.propStyle);
    this.quantity=param;
}
function com_sbokwop_test_ProductSelection_getListStyles( )
{
    return com_sbokwop_test_ProductSelection_staticgetlistStyle( );
}
function com_sbokwop_test_ProductSelection_isCompleter( )
{
    return this.getStyle( )!=null&&this.getQuantity( )>0.0;
}
function com_sbokwop_test_ProductSelection_purchase( )
{
    com_sbokwop_test_Product_doPurchase(this.style,this.quantity,false);
}
function com_sbokwop_test_ProductSelection_purchase_1( allOrNothing )
{
    com_sbokwop_test_Product_doPurchase(this.style.this.quantity,allOrNothing);
}
function com_sbokwop_test_ProductSelection_BuildPrototype( pt, priv )
{
    java_lang_Object_BuildPrototype( pt, false );
    if( priv )
        pt.classobj = com_sbokwop_test_ProductSelection_class;
    pt.com_sbokwop_test_ProductSelection_InstanceInit =
com_sbokwop_test_ProductSelection_InstanceInit;
    pt.getStyle = com_sbokwop_test_ProductSelection_getStyle;
    pt.setStyle = com_sbokwop_test_ProductSelection_setStyle;
    pt.getQuantity = com_sbokwop_test_ProductSelection_getQuantity;
    Pt.setQuantity = com_sbokwop_test_ProductSelection_setQuantity;
    pt.getListStyles = com_sbokwop_test_ProductSelectin_getListStyles;
    pt.isComplete = com_sbokwop_test_ProductSelection_isComplete;
    pt.purchase = com_sbokwop_test_ProductSelection_purchase;
    pt.purchase_1 = com_sbokwop_test_ProductSelection_purchase_1;
    pt.com_sbokwop_test_ProductSelection = com_sbokwop_test_ProductSelection;
}
function com_sbokwop_test_ProductSelection( )
{
this.com_sbokwop_test_ProductSelection_InstanceInit( );
{
    this.java_lang_Object( );
    {
    }
}
}
function com_sbokwop_test_ProductSelection_ClassInit( )
{
    com_sbokwop_test_ProductSelection_class = new java_lang_Class( jls( “com.sbokwop.test” ),
null,jls( “ProductSelection” ), false, java_lang_Object_class, [ ] );
    com_sbokwop_test_ProductSelection_BuildPrototype(
com_sbokwop_test_ProductSelection.prototype, true );
    com_sbokwop_test_ProductSelection_InnerClass_ClassInit( );
}
com_sbokwop_test_ProductSelection_StaticInitDone = false;
function com_sbokwop_test_ProductSelection_StaticInit( )
{
    if( com_sbokwop_test_ProductSelection_StaticInitDone ) return;
    com_sbokwop_test_ProductSelection_StaticInitDone = true;
    com_sbokwop_test_ProductSelection_listStyle = null;
    {
        com_sbokwop_test_ProductSelection_listStyle=na(new Array(3), “[Ljava.lang.String;” );
        com_sbokwop_test_ProductSelection_staticgetlistStyle( )[0]=“Square”;
        com_sbokwop_test_ProductSelection_staticgetlistStyle( )[1]=“Circular”;
        com_sbokwop_test_ProductSelection_staticgetlistStyle( )[2]=“Triangular”;
    }
}
function com_sbokwop_test_ProductSelection_InnerClass_setStyleByIndex( param )
{
    this._parent.setStyle(com_sbokwop_test_ProductSelection_staticgetlistStyle( )[param]);
}
function com_sbokwop_test_ProductSelection_InnerClass_BuildPrototype( pt,priv )
{
    java_lang_Object_BuildPrototype( pt, false );
    if( priv )
        pt.classobj = com_sbokwop_test_ProductSelection_InnerClass_class;
    pt.setStyleByIndex = com_sbokwop_test_ProductSelection_InnerClass_setStyleByIndex;
    pt.com_sbokwop_test_ProductSelection_InnerClass =
com_shokwop_test_ProductSelection_InnerClass;
}
function com_sbokwop_test_ProductSelection_InnerClass( _parent )
{
this._parent = _parent;
{
    this.java_lang_Object( );
    {
    }
}
}
function com_sbokwop_test_ProductSelection_InnerClass_ClassInit( )
{
    com_sbokwop_test_ProductSelection_InnerClass_class = new.java_lang_Class( jls(
“com.sbokwop.test” ), com_sbokwop_test_ProductSelection_classjls( “InnerClass” ), false,
java_lang_Object_class, [ ]);
    com_sbokwop_test_ProductSelection_innerClass_BuildPrototype(
com_sbokwop_test_ProductSelection_InnerClass.prototype, true );
}
loadClass( “java/lang/String.js” )
function com_sbokwop_test_ProductSelection_Observer_initialize( )
{
    com_sbokwop_test_ProductSelection_ClassInit( );
}
com_sbokwop_test_ProductSelection_Observer.initialize =
com_sbokwop_test_ProductSelection_Observer_initialize;
com_sbokwop_test_ProductSelection_Observer.notifyLoaded( );
```

The ClassLoaderObserver referenced at the beginning of the Javascript is an object used to ensure that all of the dependent classes are loaded before this class is initialized. In this case, the java.lang.Object class is the base class for ail Java classes and therefore must be loaded prior to ProductSelection. This is followed by a series of function definitions. The code within the functions is very similar to the code in the original Java code. There is a difference stemming from the fact that the references to fields and functions defined in the Java class have implied “this” references. The “this” identifier is used to refer to the object to which the function is “attached”. Each instance of the ProductSelection class has its own instance of the style field. When the getStyle method references the style field, it is referring to the style field in the object in which the function is being called against. Like Java, Javascript allows the attaching separate instances of the style field to each object. But, the Javascript syntax requires that the “this” identifier be used to differentiate the local object field references from global field references.

Each function name has not only the class name but also the package embedded in it. This is because, in Java, the same class name may be used in different packages and the same function name in different classes. In Javascript, function names have a global scope. Another thing to note is that there is a com_sbokwop_test_ProductSelection_purchase and a com_sbokwop_test_ProductSelection_purchase_{—}1 function. These correspond to the two purchase functions in the ProductSelection class. As mentioned above, Javascript does not support function overloading and so a qualifier needs to be appended to the functions that have the same name as other functions in the same class.

In the Java class file, there is a block of code prefixed with the “static” identifier. This is a static initializer and must be executed prior to executing any static methods or retrieving any static fields in the class.

Note: Static fields maybe accessed without having an instance of the class and static methods maybe invoked without having an instance of the class.

The static field, listStyle, is accessed in Javascript using the Javascript method com_sbokwop_test_ProductSelection_get_listStyle. Prior to returning its value, it calls the com_sbokwop_test_ProductSelection_staticInit function which executes the static initializer if it hasn't already been executed.

In the setStyle method, the compiler checks the value against the contents of listStyle. The static field reference in this case has been replaced with the call to this function.

The com_sbokwop_test_ProductSelection_buildPrototype function is used to initialize the class. It does so by assigning all of the class functions to the com_sbokwop_test_ProductSelection prototype.

This is followed by the inner class definition. The inner class serves little purpose except to illustrate how it is rendered in Javascript. The main thing to note in the inner class Javascript definition is the use of this._parent to refer to the parent instance of com_sbokwop_test_ProductSelection.

The Javascript class is followed by the more calls to the ClassLoaderObserver. This observer identities classes that need to be loaded prior to the class being used but not before the class itself is initialized.

Table 7 shows the Javascript generated for die client-side functions of a form compiled by the browser compiler. The important point to note in this Javascript is, because there is a ProductSelection field in the form, this Javascript identifies the ProductSelection javascript class file as something that must be loaded. This is done by the loadClass(“com/sbokwop/test/ProductSelection.js”) statement near the end of the file.

TABLE 7
SampleForm Client - Compiled Javascript

```
SampleForm_Client_Observer = new ClassLoaderObserver( “html/Logon_Client.js” );
SampleForm_Client_Observer.addFilename( “com/sbokwop/idml/html/runtime/HtmlCanvas.js” )
SampleForm_Client_Observer.addFilename( “java/lang/Class.js” )
loadDependentClasses( SampleForm_Client_Observer);
function SampleForm_Client_InstanceInit( )
{
    this.productSelection = mill;
    this.message = mill;
}
function SampleForm_Client_getProductSelection( )
{
    this.Prop_productSelection=com_sbokwop_alert_ObservableProperty_notifyAccess(this.Prop_productSelection);
    return this.productSelection;
}
function SampleForm_Client_setProductSelection( param )
{
    this.productSelection=param;
    com_sbokwop_alert_ObservableProperty_notifyUpdate(this.Prop_productSelection);
}
function SampleForm_Client_getMessage( )
{
    this.Prop_message=com_sbokwop_alert_ObservableProperty_notifyAccess(this.Prop_message);
    return this.pmessage;
}
function SampleForm_Client_setMessage( param )
{
    this.message=param;
    com_sbokwop_alert_ObservableProperty_notifyUpdate(this.Prop_message);
}
function SampleForm_Client_BuildPrototype( pt, priv )
{
    com_sbokwop_idml_html_runtime_HtmlCanvas_BuildPrototype( pt, false );
    if( priv )
        pt.classobj = SampleForm_Client_class;
    pt.SampleForm_Client_InstanceInit = SampleForm_Client_InstanceInit;
    pt.getProductSelection = SampleForm_Client_getProductSelection;
    pt.setProductSelection = SampleForm_Client_setProductSelection;
    pt.getMessage = SampleForm_Client_getMessage;
    pt.setMessage = SampleForm_Client_setMessage;
}
function SampleForm_Client( )
{
this.SampleForm_Client_InstanceInit( );
{
    this.com_sbokwop_idml_html_runtime_HtmlCanvas( );
    {
    }
}
}
function SampleForm_Client_ClassInit( )
{
    SampleForm_Client_class = newjava_lang_Class( null, null,jls( “SampleForm_Client” ), false,
com_sbokwop_idml_html_runtime_HtmlCanvas_class, [ ]);
    SampleForm_Client_BuildPrototype( SampleForm_Client.prototype, true );
}
loadClass( “com/sbokwop/idml/html/runtime/PrimitiveObserver.js” )
loadClass( “com/sbokwop/test/ProductSelection.js” )
function SampleForm_Client_Observer_initialize( )
{
    SampleForm_Client_ClassInit( );
}
SampleForm_Client_Observer.initialize = SampleForm_Client_Observer_initialize;
SampleForm_Client_Observer.notifyLoaded( );
```

### Server Canvas Class

Table 8 lists the contents of the Java class used for this form on the server. It is based on a superclass called HtmlCanvas. Canvas is another name for a form. The only thing that the server-side canvas class includes are the fields, the observable properties, the get and set methods for the fields and a method to initialize the data for the form.

TABLE 8
SampleForm Server Class -
Generated by Browser Compiler

```
public class SampleForm extends com.sbokwop.idml.html.runtime.HtmlCanvas
{
    private com.sbokwop.alert.ObservableProperty Prop_productSelection;
    private com.sbokwop.test.ProductSelection productSelection;
    private com.sbokwop.alert.ObservableProperty Prop_message;
    private java.lang.String message;
    public Logon( )
    {
        super( );
    }
    public com.sbokwop.test.ProductSelection getProductSelection( )
    {
        Prop_productSelection=com.sbokwop.alert.ObservableProperty.notifyAccess(
            Prop_productSelection);
        return productSelection;
    }
    public void setProductSelection( com.sbokwop.test.ProductSelection param )
    {
        productSelection=param;
        com.sbokwop.alert.ObservableProperty.notifyUpdate(Prop_productSelection);
    }
    public String getMessage( )
    {
        Prop_message=com.sbokwop.alert.ObservableProperty.notifyAccess(Prop_message);
        return message;
    }
    public void setMessage( String param )
    {
        message=param;
        com.sbokwop.alert.ObservableProperty.notifyUpdate(Prop_message);
    }
    public void initialize( )
        throws java.lang.Exception
    {
    }
}
```

### Initial Dynamic Server File

The initial dynamic server file for a form is what builds the HTML that the browser initially displays as well as the Javascript to initialize the client-side data for the form. Table 9 is a sample Java Server Page (JSP) for the sample form example from above. The Java Server Page is the means of building dynamic server files on Java-based web servers.

TABLE 9
Initial JSP File for Sample Form

```
<%
SampleFormCanvas cnv = new SampleFormCanvas( );
cnv.initialize( );
%>
<HTML>
<HEAD>
<SCRIPT>
function onLoad( )
{
    Obs = jvm.createAnonymousObserver( onReady );
    Obs.addFilename ( “SampleFormClient.js” );
    jvm.loadDependentClasses( Obs );
}
function onReady( )
{
    cnv = new jvm.SampleFormClient ( );
    <% cnv.outputServerToClientTrasfer(out); %>
    var obs = new jvm.com_sbokwop_html_runtime_PrimitiveObserver( );
    obs.performUpdate = new Function( “document.getElementedById(‘buttonPurchase’).enabled =
        cnv.getProductSelection( ).isComplete( );” );
    obs.initialize( );
    cnv.addPropertyObserver( obs );
    var obs = new jvm.com_sbokwop_html_runtime_PrimitiveObserver( );
    obs.performUpdate = new Function( “document.getElementedById(‘textMessage’).innerText =
        cnv.getMessage( );” );
    obs.initialize( );
    cnv.addPropertyObserver( obs );
    makeThisVisibleFrame( );
}
fucntion editStyleBox_change( )
{
    cnv.getProductSelection( ).setStyle( document.getElementById(“editStyleBox”).value );
}
fuction editQuantityBox_change( )
{
    cnv.getProductSelection( ).setQuantity(
        convertNumeric( document.getElementById(“editQuatityBox”).value ) );
}
</SCRIPT>
</HEAD>
<BODY onload=”onLoad( )”>
<DIV style=”position:absolute;left:100;top:100;width:60;height:20”>Style</DIV>
<INPUT id=”editStyleBox” type=”TEXT” style=”position:absolute;left:160;top:100;width:60;height:20”
    onchange=”editStyleBox_change” value=”<%=cnv.getProductSelection( ).getStyle( )%>”/>
<DIV style=”position:absolute;left:100;top:130;width:60;height:20”>Quantity</DIV>
<INPUT id=”editStyleBox” type=”TEXT” style=”position:absolute;left:160;top:130;width:60;height:20”
    onchange=”editQuantityBox_change” value=”<%=cnv.getProductSelection( ).getQuantity( )%>”/>
<BUTTON id=”btnPurchase” style=”position:absolute;left:100;top:200;width:100;height:20”
    enabled=”<%=cnv.getProductSelection( ).isComplete( )%>”
    onclick=”invokeServerAction(‘SampleForm_purchase.jsp’)“ >Purchase</BUTTON>
<DIV style=”position:absolute;left:100;top:300;width:100;height:20”><%=cnv.getMessage( )%></DIV>
</BODY>
</HTML>
```

The JSP file begins by instantiating the server canvas class described above and initializing the data in that object. This code is enclosed in <% and %>. This is the Java Server Page syntax to denote code that should be executed on the server rather than the client.

The Javascript onLoad function is executed by the BODY element once the page has been fully loaded. It tells the Javascript class loader to load the client class. The Javascript for the canvas class in turn ensures that the ProductSelection Javascript class is loaded. Once both Javascript classes have been loaded, the onReady function is called.

In the onReady function, the client-side canvas class is instantiated first. After this, there is server-side code. The call to cnv.outputServerToClientTransfer(out) causes server-side code to generate Javascript to transfer the form's fields from the server to the client.

After this, the Javascript code creates a PrimitiveObserver object. The PrimitiveObserver object is what implements the observer process described above. The next section describes how it works in more detail. The new PrimitiveObserver object is assigned a performUpdate function using Javascript to assign the HTML object's attribute using the expression assigned to it.

This is followed by a call to makeThisVisibleFrame( ). This is what causes a new form that has been loaded into a hidden frame to become visible. This is described in more detail below.

This function is followed by the Javascript functions that are invoked by the <INPUT> tags in the HTML below. These are generated by the EditBox primitive of the browser compiler. This Javascript invokes the set methods associated with the fields to which the EditBox “data” property is bound.

All of this script is followed by the HTML that defines the form's appearance. The <DIV> tags are used to render the Text primitives. The <INPUT> tags are used to render the EditBox primitives. The <BUTTON> tag is used to render the Button primitive.

Some of these tags have server-side code embedded in them. This is denoted by the same delimiters as mentioned above, <% and %>. The use of “=” after the initial delimiter indicates that the contents are a Java expression which should be evaluated and then translated to a String and embedded in that location in the HTML. In this case, the tag attributes are being assigned with values that are calculated on the server.

The BUTTON onclick event handier calls a Javascript function to invoke the purchase action server file. The invokeServer Action function creates a FORM object and posts all of the data in the client canvas class to the JSP file passed as a parameter.

### Purchase Action Dynamic Server File

Table 10 lists the dynamic server file for the purchase action of SampleForm.

TABLE 10
JSP File for purchase Action

```
<%
SampleFormCanvas cnv = new SampleFormCanvas( );
    cnv.transferClientToServer(request);
if( Product.purchase( cnv.getProductSelection( ) ) )
{
cnv.getNavigator( ).swap( “EnterPaymentDetails”,
cnv.getProductSelection( ) );
}
else
{
    cnv.setMessage( ”Product not purchase” );
}
if( cnv.getNavigator( ).loadingNewForm( ) ) {
getNavigator( ).redirect( getNavigator( ).getNewForm( ) );
} else {
%>
<HTML>
<SCRIPT>
function onLoad( )
{
cnv.outputServerToClientTrasfer(out);
}
</SCRIPT>
<BODY onload=”onLoad”>
</BODY>
</HTML>
<% } %>
```

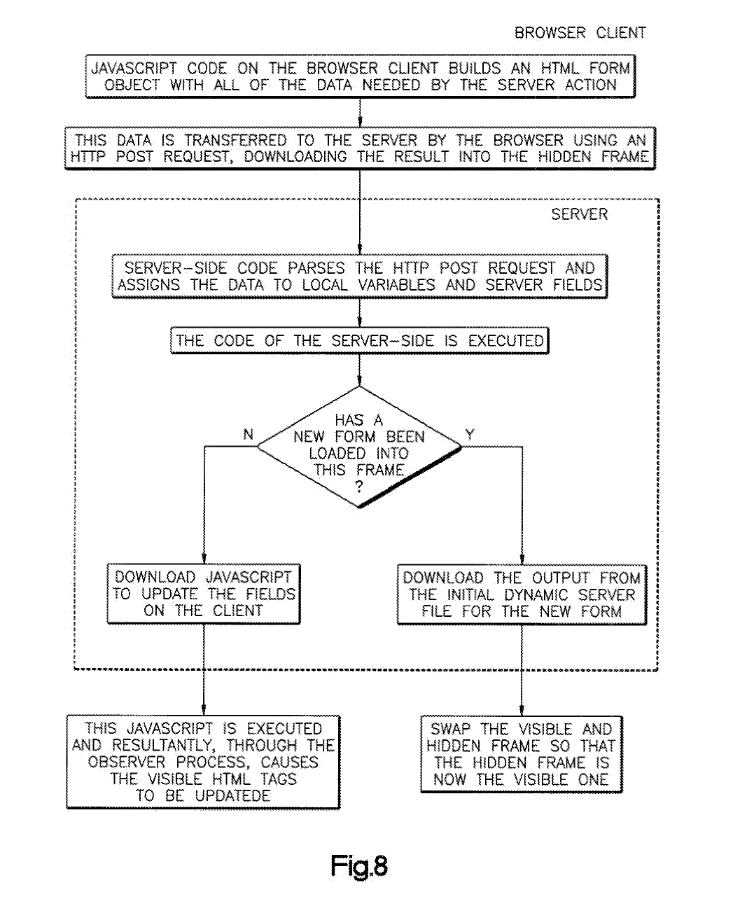

### FIG. 8 depicts how a server action is implemented.

Just as with the initial server file for the Sample form, the action's dynamic server file, starts by instantiating the server-side class using server-side code.

Then, the form fields are transferred from the client to this server object. This is done by extracting the data posted to the server by the invokeServerAction function called by the BUTTON object.

The transfer of data is followed by the code defined in the action, with all implicit references to the canvas fields and actions replaced by explicit references to the “cnv” object created at the beginning of the file.

The end of the server-side code is to inspect the navigator field (as returned by the getNavigator function) to determine if a new form is to be swapped. If yes, then the request is redirected to the initial JSP file for the new form. Though the invokeServerAction called upon the purchase action JSP file to be downloaded, this redirection causes the initial JSP file for the new form to be downloaded instead.

The initial JSP file for the new form will invoke makeThisVisibleFrame just as the initial JSP file did for the SampleForm.

Each browser client window (or frame within a window) actually consists of two frames, one of which is hidden and one of which is displayed. The result of server actions are downloaded into the hidden frame. When a new form is loaded as a result of a server action, the initial page for the form calls the makeThisVisibleFrame function. This function causes the visible frame to become invisible and the invisible frame that now contains the new form to become visible.

If the navigator field does not indicate that a new form is to be loaded into the frame, then the JSP file outputs Javascript that causes the fields in the server canvas class to be transferred to the client canvas class. This, in return, causes the form to be updated through the observer process referred to above. In this case, the textMessage primitive is updated to show the new contents of the message field.

### Capturing Observables

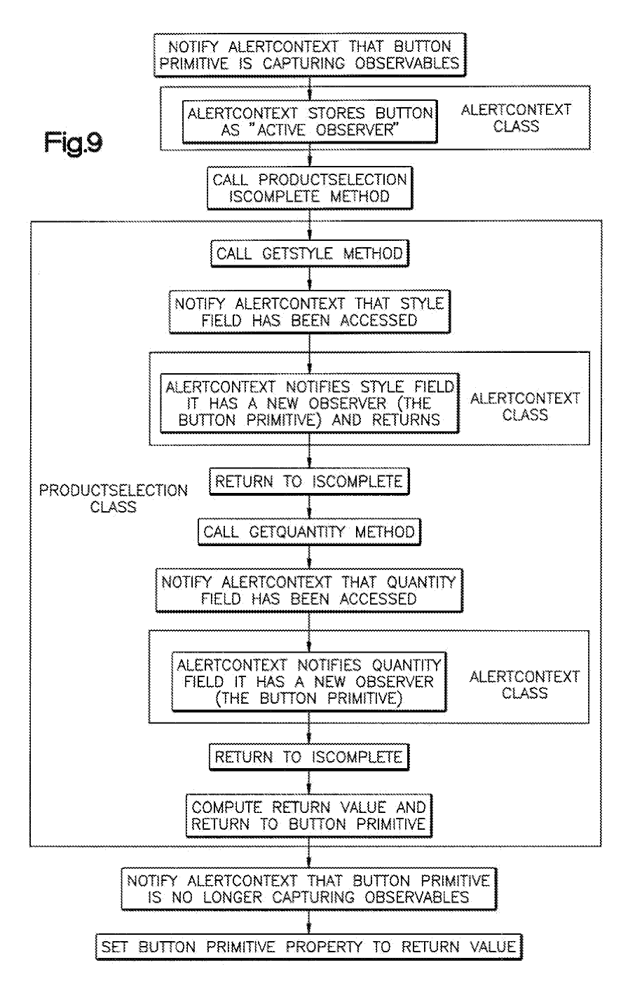

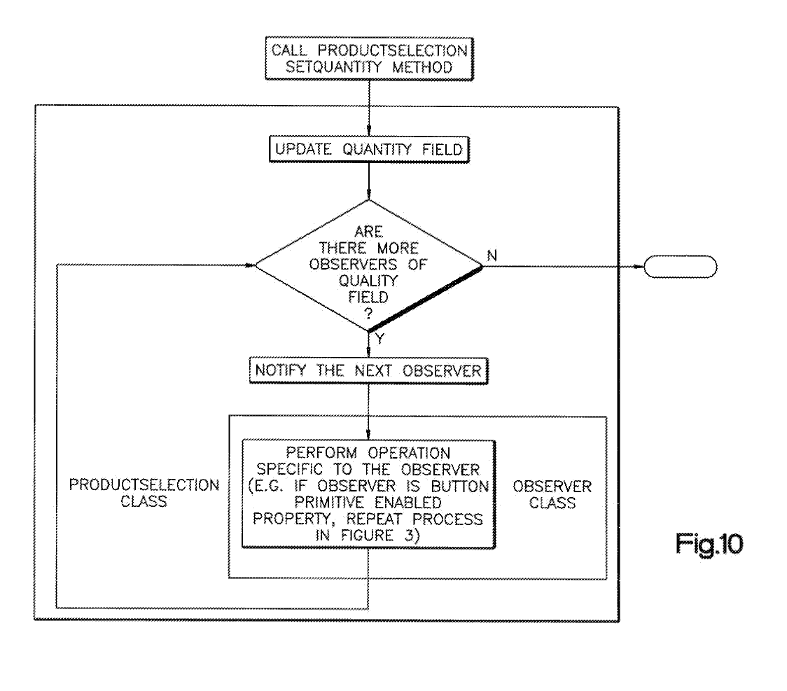

FIG. 9 and FIG. 10 illustrate the use of observables and observers in the IDML technology.

The exemplary browser technology compiler uses a PrimitiveObserver object to keep HTML tag attributes up to date. Other Observer objects may be used to implement the same function.

In FIG. 9, the PrimitiveObserver sets the current value of the Button's enabled property and simultaneously captures the observables which might, in the future, change and, as a result, cause the expression defining the value of the enabled property to change.

The PrimitiveObserver starts by notifying the AlertContext class that it is now capturing observables. The AlertContext class is responsible for retaining this information for use in future method calls.

The enabled property is defined as productSelection.isComplete( ) which means that it should always be set to the return value of the isComplete method of the productSelection field. The next step then is to call the isComplete method.

The isComplete method is defined by the Java class of the productSelection field which is called ProductSelection (Java is case-sensitive). The isComplete method first calls the getStyle method which is also defined in the ProductSelection class. The style field is an observable so the first thing getStyle does is to notify AlertContext that an observable has been accessed.

The AlertContext has recorded the fact that the PrimitiveObserver is capturing observables and so it informs the ProductSelection class that the Button primitive should be added as an observer of the style field. The ProductSelection class must retain this information.

The getStyle method returns the current value of the style field to the isComplete method. It then immediately calls the getQuantity method. The process used for the style field is repeated for the quantity field.

The isComplete method now has the value of both the style field and quantity field. If both of them are filled in with some value, it returns a value of true. Otherwise, it returns false.

The PrimitiveObserver retains this return value and then tells AlertContext that it is no longer capturing observables, ensuring that future accesses of observable properties are not attached incorrectly to it.

As a last step, the PrimitiveObserver sets the Button's enabled property so that the visual representation of the button reflects the fact that of whether it is enabled and which impacts what happens when the user clicks on the button.

After this process is completed, not only is the enabled property set, but the style and quantity properties are now aware that they must notify the PrimitiveObserver when they change because that might cause the property value to change.

### Notifying Observers

As identified in FIG. 9, the quantity field is aware of which observers need to know when its value changes, including the PrimitiveObserver for the Button enabled property.

FIG. 10 shows the process when an EditBox primitive has its data property bound to this quantity field and the user enters a new value in that box. The EditBox primitive first calls the setQuantity method in the ProductSelection class.

The setQuantity method begins by assigning the new value to the quantity field. Once that is done, since the quantity field is an observable, it is responsible for notifying all of the observers of that field. Therefore, it has to loop though all of the observers in the list of observers for that field and notify each one.

Since the PrimitiveObserver for the Button enabled property is an observer of that field, it is one of the observers notified. As a result, it re-executes the process in FIG. 16 again.

### Collection Update Notices

The last complexity involved in implementing the browser compiler revolved around the need to manage potentially large collections of elements (such as records in a table) and the possible run-time updates that might occur to those collections.

As mentioned above, the observer process includes the ability for collections of elements to provide specialized update notifications when single elements are inserted, changed or deleted. This allows the user interface technology to optimize how it responds to such notices by dealing with the change identified rather than re-displaying the entire collection.

Processing these specialized update notices in a manner that was within acceptable performance constraints within the browser client posed some unique problems. A solution was devised that required the initial HTML rendering process of a form to include a “template” block of HTML. This is used to render new and updated elements. When an insert or change update notice is received, this template block is cloned and then Javascript generated by the browser compiler is executed to customize this cloned version of the template to conform with the data for the new element.

An exemplary embodiment of the invention has been described with a degree of particularity. It is the intent that those designs departing from the exemplary embodiment falling within the spirit or scope of the claims are considered to be covered by the invention.

1. A process for creating a data file for evaluation by a user interface technology compiler comprising:
a) providing definition code that defines display components;
b) designing a display module or form that utilizes one or more of the display components; and
c) distilling the display module into a generic file by creating a set of primitives and optionally fields and actions (which contain executable code) corresponding to the display components that multiple user interfaces can represent.

2. The method of claim 1 wherein the contents of the data file is instead retained as a data structure in the computer memory!

3. The method of claim 1 wherein the code for each display component distills instances of that component into primitive types from a pre-defined set of primitive types that are understood by multiple user interface technology compilers.

4. The method of claim 1 wherein the display module contains user-defined fields and actions in addition to display components and these are included in the generic file created by the process.

5. The method of claim 1 additionally comprising converting the primitives, and any fields and actions into executable code.

6. The process of claim 1 wherein the generic code is converted by a user interface compiler designed for a particular user interface technology.

7. The method of claim 4 wherein the distilling comprises adding display module observer code to the primitives that allow said primitives to be updated in response to changes in observable data as the executable code executes.

8. The method of claim 7 wherein the primitives add all observables that are accessed in the execution process.

9. The method of claim 2 wherein the primitive comprises a number of properties that are each defined using an expression whose value may change as the execution code executes.

10. The method of claim 8 wherein the primitive separately adds observer code for each property for the observables that are accessed in evaluating the current value of the expressions that define them.

11. The method of claim 3 wherein certain of the executable code is for execution on a server to update a client display and certain other of the code is for execution on a client communicating with the server.

12. The method of claim 3 wherein the executable code is generic to a number of different technology interlaces.

13. A process for creating a generic data file for evaluation by a user interface application program comprising:
a) designing a display module or form that utilizes one or more display components;
b) distilling components of the display module into an intermediate data store having a set of primitives and optionally fields and actions for each display component; said primitives comprising a fixed set of properties; and
c) compiling the primitives, any fields and any actions into executable code, said executable code including server code executable on a web server and client code executable by a client communicating with the web server.

14. The process of claim 13 wherein the compiling is performed by a development tool that generates data files that are accessed by the client code executable and optionally a server code executable upon execution of the client code executable.

15. The process of claim 13 wherein the compiling is performed by the server code executable in response to a request from client executable code to display one or more specific forms.

16. The process of claim 13 wherein the compiling is performed by a plug in component that is executed within a server code executable developed by a third party.

17. Apparatus comprising a web server and one or more client computers, wherein the web server comprises:
static files generated by a user interface technology compiler to describe information such as text styles specifying fonts, colours, etc;
executable code generated by a user interface technology compiler to generate the file(s) to be sent to the client application;
wherein the file generated by the executable code contains the data needed to render the initial state of each primitive;
wherein the code will monitor observables accessed in determining the initial state of each primitive;
wherein the file generated installs in the client application the code required to respond to observable events;
wherein the file generated installs in the client application the code to invoke executable code in actions that have to be implemented on the server;
executable code generated by a user interface technology compiler to implement actions that have to be implemented on the server and
a communications module for communicating a subset of the executable code to the one or more client computers for updating the client computers on occurrence of an observable event during the execution of the server action.

18. Apparatus comprising a web server and one or more client computers, wherein the web server comprises:
a generic data conversion module for interpreting a user interface in the form of a number of display components and converting said components into a generic data structure defining all primitives for the display;
a user interface compiler for converting the generic data structure into executable code to generate the file to be sent to the client application in order to display the initial state of the primitives and to monitor observables on a user interface display module; and
a communications module for communicating a subset of the executable code to the one or more client computers for updating the client computers on occurrence of observable event(s).

19. The apparatus of claim 18 wherein the client display comprises two frames, a visible frame and an invisible frame;
wherein the client application downloads the results of actions invoked on the server into the invisible frame;
wherein the server, when the server action does not cause a new form to be displayed, causes executable code to be downloaded into the invisible frame in order to update the client computer in response to the occurrence of observable event(s); and
wherein the server, when the server action causes a new form to be displayed, downloads the data to the client that represents the initial state of the primitives of this new form into the invisible frame and directs the client to render the contents of the invisible frame to be visible and the visible frame to be invisible upon the occurrence of a specified event.

20. A process in which a generic data model representing object-oriented code is generated by parsing an object-oriented programming language such as Java™ or C++, into executable Javascript code.

21. The method of claim 20 in which a class with multiple functions containing the same name are mapped to functions with unique function names and any invocations of those functions use the modified, unique function name.

22. The method of claim 20 in which, when one or more Javascript classes are loaded by the application, the Javascript files for those classes and each class that they may access are also loaded and operation of the application is suspended until all of these Javascript files are loaded asynchronously.

23. The method of claim 20 wherein a Javascript class file contains a function to execute all static initializers in the class;
wherein that function is called at the beginning of functions created to implement static field retrievals as well as all static functions and all constructors of the class;
wherein every access of the static field of another class is implemented as a call to the function created to implemented the static field retrieval so that the static initializer may be executed first.

24. The method of claim 20 wherein Javascript is generated for a class that is nested within another parent class;
wherein the nested class has an implied, hidden field referring to the instance of the parent class; and
wherein the Javascript generated for the nested class automatically inserts the reference to this hidden field when the code in the nested class references a field or function in the parent class.
